(19) United States
(12) Patent Application Publication
(10) Pub. No.: US 2015/0357618 A1
(43) Pub. Date: Dec. 10, 2015

(54) LITHIUM-ION CELL

(71) Applicant: SANYO Electric Co., Ltd., Daito-shi, Osaka (JP)

(72) Inventor: Tatsuki Hiraoka, Hyogo (JP)

(73) Assignee: SANYO Electric Co., Ltd., Daito-shi, Osaka (JP)

(21) Appl. No.: 14/761,765

(22) PCT Filed: Mar. 20, 2014
(86) PCT No.: PCT/JP2014/001622

§ 371 Date: Jul. 17, 2015

(30) Foreign Application Priority Data
Mar. 29, 2013 (JP) 2013-071443

(51) Int. Cl. H01M 2/16; H01M 10/0525

(52) U.S. Cl. CPC H01M 2/1686; H01M 10/0525

(57) ABSTRACT

A leak test defect is suppressed which is generated by short circuit between a positive electrode and a negative electrode with a lithium metal present in the vicinity of an end portion of a separator, and an initial charge/discharge efficiency of a lithium-ion cell and cycle characteristics thereof are improved. In the lithium-ion cell, the separator includes a polyolefin as a primary material and a uniform lithium metal film formed on a surface portion thereof which is located at the negative electrode plate side and which does not face the negative electrode active material layer, and the lithium metal film is electrically insulated from the positive electrode collector.

### TECHNICAL FIELD

The present invention relates to a lithium-ion cell and in particular, relates to a lithium-ion cell separator.

### BACKGROUND ART

In order to increase the energy density of a lithium-ion cell and the output thereof, as a negative electrode active material, instead of using a carbonaceous material, such as graphite, the use of a metal material, such as silicon, germanium, tin, or zinc, which forms an alloy with lithium, an oxide of the metal material mentioned above, and the like has been studied.

As a negative electrode active material formed of a metal material which forms an alloy with lithium or an oxide of the metal material, for example, when silicon is used, since lithium can be inserted thereinto to form a composition of Li_{4.4}Si, a large theoretical capacity can be obtained as compared to that of a graphite-based carbonaceous material in which lithium can only be inserted to form a composition of at most LiC₆.

Incidentally, even if any type of negative electrode active material is used, although lithium is incorporated into the negative electrode active material from a positive electrode active material during a first charge, all the lithium thus incorporated cannot be extracted during discharge, and an unspecific amount thereof is fixed in the negative electrode active material, so that an irreversible capacity is generated.

The irreversible capacity of the negative electrode active material formed from a metal material which forms an alloy with lithium or an oxide of the metal material is large as compared to that of a carbonaceous material, and as a result, there may be a problem in that the cell capacity does not reach a desired value.

PTL 1 has disclosed a lithium-ion cell separator in which a lithium powder having an average particle size of 20 μm, the surface of which is processed by a stabilization treatment, is adhered to a separator formed of a polyolefin as a primary material. According to the lithium-ion cell separator disclosed in PTL 1, since lithium can be supplemented to the negative electrode in an amount corresponding to the irreversible capacity by the lithium powder processed by the stabilization treatment, the cell capacity can be improved.

In addition, since no lithium is mixed in a negative electrode mixture layer, lithium is not deactivated, and hence, an environment in which lithium is not allowed to react is not required before a cell group formation step is performed.

### CITATION LIST

### Patent Literature

PTL 1: Japanese Published Unexamined Patent Application No. 2008-84842

### SUMMARY OF INVENTION

### Technical Problem

However, when a square cell or a laminate cell is formed using the lithium-ion cell separator disclosed in PTL 1, at the outermost circumference side of a cell group, there is a portion at which an end portion of the separator is in contact with a positive electrode collector.

In addition, since the lithium powder is present in the vicinity of the end portion of the separator, the positive electrode is short-circuited to the negative electrode with the lithium powder provided therebetween, so that leak test defects and degradation in safety caused by internal short circuit may occur in some cases.

### Solution to Problem

A lithium-ion cell of the present invention comprises: a positive electrode plate including a positive electrode collector and a positive electrode active material layer formed on a surface of the positive electrode collector; a negative electrode plate including a negative electrode collector and a negative electrode active material layer formed on a surface of the negative electrode collector; a separator separating the positive electrode plate from the negative electrode plate; and a non-aqueous electrolytic solution containing a non-aqueous solvent and an electrolytic salt. In this lithium-ion cell, the separator includes a polyolefin as a primary material and a uniform lithium metal film formed on a surface portion thereof which is located at a negative electrode plate side and which does not face the negative electrode active material layer, and the lithium metal film is electrically insulated from the positive electrode collector.

### Advantageous Effects of Invention

In the lithium-ion cell of the present invention, since a lithium metal film located at a portion facing the negative electrode active material layer is incorporated in the negative electrode active material, and the degradation in safety, such as internal short circuit, caused by a remaining lithium metal layer can be suppressed, a lithium-ion cell having a high initial charge/discharge efficiency, excellent cycle characteristics, and no leak test defects can be obtained.

### BRIEF DESCRIPTION OF DRAWINGS

FIG. 1 is a perspective view of a flat electrode body.

FIG. 2A is a front schematic view of a flat lithium-ion cell according to one aspect of the present invention, and FIG. 2B is a cross-sectional view taken along the line IIB-IIB of FIG. 2A.

FIG. 3 is an enlarged view of a wound terminal portion of FIG. 2B.

### DESCRIPTION OF EMBODIMENTS

Hereinafter, a lithium-ion cell of the present invention will be described in detail with reference to various experiment examples. However, the following experimental examples are each described to explain one example of a lithium-ion cell which realizes the technical scope of the present invention, and it is not intended to limit the present invention to any one of those experiment examples. The present invention may also equally include various modifications which are performed on those experiment examples without departing from the technical scope disclosed in Claims.

### Experimental Example 1

A lithium-ion cell of Experimental Example 1 was formed as described below.

### (Formation of Positive Electrode)

A mixture of 100 parts by mass of lithium cobalt composite oxide (LiCoO₂), 1.5 parts by mass of acetylene black, 1.5 parts by mass of a poly(vinylidene fluoride), and an appropriate amount of N-methylpyrrolidone (NMP) was formed using a mixer, so that a positive electrode mixture slurry was prepared.

This positive electrode mixture slurry was applied on two surfaces of a positive electrode collector sheet formed of Al foil having a thickness of 15 μm and was then dried and rolled. Subsequently, this rolled sheet was cut to have a size corresponding to a cell case formed of a predetermined laminate material, so that a positive electrode to be used in the lithium-ion cell of Experimental Example 1 was obtained. The charge capacity of this positive electrode was 3.6 mAh/cm².

### (Formation of Negative Electrode)

A mixture of 10 parts by mass of SiO particles having an average particle diameter (D₅₀) of 6 μm, 90 parts by mass of graphite particles having an average particle diameter (D₅₀) of 25 μm, 1 part by mass of a carboxymethyl cellulose (CMC) functioning as a thickening agent, 1 part by mass of a styrene-butadiene rubber (SBR) functioning as a binder, and an appropriate amount of water was formed using a mixer, so that a negative electrode mixture slurry was prepared.

This negative electrode mixture slurry was applied on two surfaces of a negative electrode collector sheet formed of copper foil having a thickness of 10 μm and was then dried and rolled. Subsequently, this rolled sheet was cut to have a size corresponding to the cell case formed of a predetermined laminate material, so that a negative electrode to be used in the lithium-ion cell of Experimental Example 1 was obtained. The charge capacity of this negative electrode was 5.0 mAh/cm².

### (Formation of Lithium Metal Film on Separator)

A polypropylene-made fine porous film having a thickness of 20 μm was used as a base material, a uniform lithium metal film was provided by a vacuum deposition method (lithium source was evaporated by resistance heating) to have a thickness of 4.0 μm, so that a separator to be used in the lithium-ion cell of Experimental Example 1 was obtained.

### (Formation of Lithium-Ion Cell)

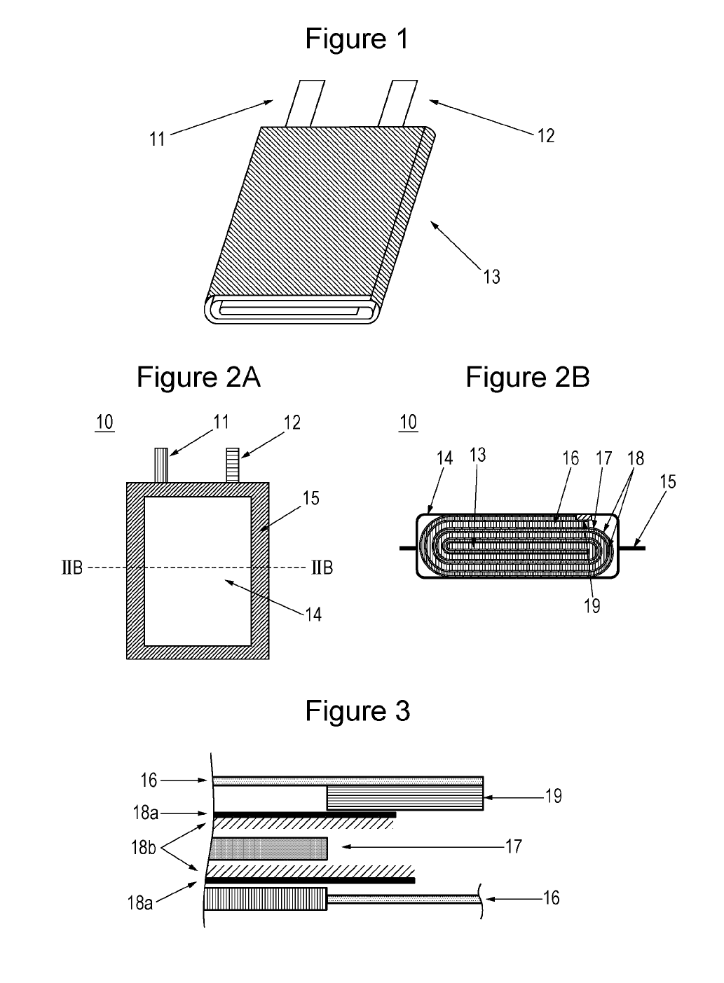

A concrete process for manufacturing a lithium-ion cell 10 of Experimental Example 1 will be described with reference to FIGS. 1 to 3. A positive electrode tab 11 was welded to an end portion of a positive electrode collector of a positive electrode 16 formed as described above, and as in the case described above, a negative electrode tab 12 was welded to an end portion of a negative electrode collector of a negative electrode 17. Subsequently, the positive electrode 16 and the negative electrode 17 were wound with two separators 18 formed as described above to have a spiral shape so that the positive electrode 16 and the negative electrode 17 were insulated from each other and so that the positive electrode tab 11 and the negative electrode tab 12 were each located at the outermost circumferential side. In this step, the lithium metal films were each disposed to face the negative electrode. Next, an insulating winding stop tape was fitted to a wound terminal portion.

Furthermore, as shown in FIGS. 2B and 3, an insulating tape 19 was adhered to the positive electrode collector at a portion in contact with a separator terminal portion. Subsequently, pressing was performed, so that as shown in FIG. 1, a flatly wound electrode group 13 was obtained.

As an external package 14, as shown in FIGS. 2A and 2B, containers were used which were each formed in advance from an aluminum laminate film material so as to be able to accommodate the flatly wound electrode group 13 formed as described above.

In addition, the flatly wound electrode group 13 and the non-aqueous electrolytic solution prepared as described above were received in the external package 14 at 25° C. in a carbon dioxide atmosphere at one atmospheric pressure, and end portions of the aluminum laminate materials were heat-sealed with each other to form a closing portion 15, so that the flat lithium-ion cell 10 of Experimental Example 1 having the structure shown in FIGS. 2A and 2B was formed.

### Experimental Example 2

As a lithium-ion cell of Experimental Example 2, the structure similar to that of Experimental Example 1 was formed except that the insulating tape 19 was not adhered, and the separators, on each of which the lithium metal film was formed, were further wound around the electrode group once.

### Experimental Example 3

As a lithium-ion cell of Experimental Example 3, the structure similar to that of Experimental Example 1 was formed except that the insulating tape 19 was not adhered to the positive electrode collector, and 5 mm of the lithium metal film from the edge surface of the outermost circumference of the separator is removed.

### Comparative Example 1

As a lithium-ion cell of Comparative Example 1, the structure similar to that of Experimental Example 1 was formed except that the insulating tape 19 was not adhered to the positive electrode collector.

### Comparative Example 2

As a lithium-ion cell of Comparative Example 2, the structure similar to that of Experimental Example 1 was formed except that the lithium metal film was not formed on the separator.

### [Leak Defect Test]

A withstand voltage test at 200 kV was performed on the lithium-ion cell formed as described above in each of Experimental Examples 1 to 3 and Comparative Examples 1 and 2.

### [Measurement of Cell Characteristics]

In addition, the initial charge/discharge efficiency and the capacity retention rate were measured as described below. Incidentally, the following measurements were all performed in an atmosphere at 25° C.

### (Measurement of Initial Charge/Discharge Efficiency and Cell Thickness)

The lithium-ion cell immediately after assembled in each of Experimental Examples 1 to 3 and Comparative Examples 1 and 2 was charged at a constant current of 0.5 It until the cell voltage reached 4.3 V, and after the cell voltage reached 4.3 V, charge was performed at a constant voltage of 4.3 V until the charge current reached 0.05 It. The electric quantity that flowed in this step was obtained as a first charge capacity. Subsequently, discharge was performed at a constant current of 0.2 It until the cell voltage reached 3.0 V, and the electric quantity that flowed in this step was obtained as a first discharge capacity. In addition, the initial charge/discharge efficiency was obtained based on the following equation.

Initial charge/discharge efficiency(%)=(first charge capacity/first discharge capacity)×100

In addition, after the first charge/discharge was completed, the thickness of the cell was measured which was charged under the conditions similar to those of the first charge/discharge.

### (Capacity Retention Rate)

The lithium-ion cell immediately after assembled in each of Experimental Examples 1 to 3 and Comparative Examples 1 and 2 was charged at a constant current of 0.5 It until the cell voltage reached 4.3 V, and after the cell voltage reached 4.3 V, charge was performed at a constant voltage of 4.3 V until the charge current reached 0.05 It. Subsequently, discharge was performed at a constant current of 1.0 It until the cell voltage reached 3.0 V, and the electric quantity that flowed in this step was obtained as a first cycle discharge capacity. This charge/discharge was regarded as one cycle and was repeatedly performed 200 times, and the electric quantity that flowed at a 200-th cycle was obtained as a 200-th cycle discharge capacity. In addition, the capacity retention rate at a 200-th cycle was obtained based on the following equation. The results are collectively shown in Table 1.

Capacity Retention Rate(%)=(200-th cycle discharge capacity/First cycle discharge capacity)×100

TABLE 1

| | Experimental | Experimental | Experimental | Comparative | Comparative |
|---|---|---|---|---|---|
| | Example 1 | Example 2 | Example 3 | Example 1 | Example 2 |
| Leak Test | ◯ | ◯ | ◯ | X | ◯ |
| Initial Charge/ | 91% | 91% | 91% | 79% | 82% |
| Discharge Efficiency | | | | | |
| Initial Cell Thickness | 3.57 mm | 3.66 mm | 3.63 mm | 3.55 mm | 3.48 mm |
| Capacity Retention | 88% | 90% | 90% | 49% | 79% |
| Rate | | | | | |

From the results shown in Table 1, the following is found. Since the difference in structure among the cells of Experimental Examples 1 to 3, Comparative Example 2, and Comparative Example 2 is whether the lithium metal film is in contact with the positive electrode (Comparative Example 1) or not (Experimental Examples 1 to 3 and Comparative Example 2), in the leak test, a defect was generated only in the cell of Comparative Example 1.

As for the initial charge/discharge efficiency, since an appropriate amount of Li is supplied to the negative electrode from the lithium metal film of the cell of each of Experimental Examples 1 to 3, the cell has a high charge/discharge efficiency as compared to that of the cell of Comparative Example 2. On the other hand, when the electrolytic solution is charged to the wound body of Comparative Example 1, the positive electrode is short-circuited to the negative electrode through the lithium metal film provided therebetween, and furthermore, the positive electrode is over-discharged since being brought into contact with the lithium metal, so that the charge/discharge efficiency is degraded.

When the charge/discharge cycle was repeatedly performed on the cell of each of Experimental Examples 1 to 3, a lithium metal film located at a portion at which the separator faces the negative electrode is lost since lithium is supplemented to the negative electrode. However, in a lithium metal film located at a portion at which the separator does not face the negative electrode, since lithium is not supplemented to the negative electrode, even if the charge/discharge cycle is repeatedly performed, the lithium metal film remains.

After diffused to both the positive electrode and the negative electrode, the lithium metal film of the cell of Comparative Example 1 remains as in the cell of each of Experimental Examples 1 to 3.

As for the capacity retention rate, the results of the cells of Experimental Examples 1 to 3 were approximately equivalent to each other, but the capacity retention rate of the cell of Comparative Example 1 was inferior to that of the cell of Comparative Example 2. In the cell of Comparative Example 1, since lithium is not only diffused to the negative electrode during the solution supply but is also supplied to the positive electrode side due to short circuit, it is inferred that degradation of the positive electrode active material is promoted, and the capacity retention rate was decreased.

The thickness of the cell of each of Experimental Examples 1 and 2 is increased as compared to that of the cell of Experimental Example 3. Since it is believed that the thickness of the cell of Experimental Example 1 is increased in an amount corresponding to that of the insulating tape (0.05 mm) and that the thickness of the cell of Experimental Example 2 is increased in an amount corresponding to that of the separators wound around the electrode group once (0.08 mm), the increase in thickness approximately corresponds to that described above.

In Experimental Example 1, although the thickness of the lithium metal film was set to 4 μm, the thickness thereof is not particularly limited. However, an appropriate thickness of the lithium metal film is changed depending on the irreversible capacity of a negative electrode active material to be used, and the thickness is preferably 2 to 26 μm. When the thickness of the lithium metal film is excessively small, the supplement corresponding to the irreversible capacity cannot be sufficiently performed to the negative electrode active material layer, and as a result, the initial efficiency and the cycle characteristics may not be sufficiently improved in some cases. When the thickness of the lithium metal film is excessively large, lithium is liable to be deposited on the negative electrode, and the safety may be degraded in some cases.

In addition, in the cell of Experimental Example 3, although 5 mm of the lithium metal film was cut from the edge surface of the outermost circumference of the separator, as long as the width of the lithium metal film to be removed is larger than the thickness thereof, a separator base material portion, which is obtained after the lithium metal film is removed, is wound around so as to cover the end portion of the lithium metal film, the internal short circuit caused by the lithium metal film can be suppressed.

### INDUSTRIAL APPLICABILITY

A negative electrode for lithium-ion cells according to one aspect of the present invention and a lithium-ion cell using the negative electrode described above may be applied, for example, to drive power sources of mobile information terminals, such as a mobile phone, a notebook personal computer, and a PDA and in particular, to applications which require a high energy density. In addition, it is also expected that the negative electrode and the lithium-ion cell described above may also be further applied to high output applications, such as an electric vehicle (EV), a hybrid electric vehicle (HEV, PHEV), and an electric tool.

### REFERENCE SIGNS LIST

10 lithium-ion cell
11 positive electrode tab
12 negative electrode tab
13 wound electrode group
14 external package
15 closing portion
16 positive electrode
17 negative electrode
18 separator
18a separator substrate
18b lithium metal film 19 insulating tape

1. A lithium-ion cell comprising:
a positive electrode plate including a positive electrode collector and a positive electrode active material layer formed on a surface of the positive electrode collector;
a negative electrode plate including a negative electrode collector and a negative electrode active material layer formed on a surface of the negative electrode collector;
a separator separating the positive electrode plate from the negative electrode plate; and
a non-aqueous electrolytic solution containing a non-aqueous solvent and an electrolytic salt,
wherein the separator includes a polyolefin as a primary material and a uniform lithium metal film formed on a surface portion thereof which is located at the negative electrode plate side and which does not face the negative electrode active material layer, and
the lithium metal film is electrically insulated from the positive electrode collector.

2. The lithium-ion cell according to claim 1, further comprising a non-electrically conductive substance between the lithium metal film and the positive electrode collector.

3. The lithium-ion cell according to claim 1, wherein an end portion of the lithium metal film is located at a position apart from an edge surface of the separator by a predetermined width or more, and the predetermined width corresponds to the thickness of the lithium metal film.

4. The lithium-ion cell according to claim 1, wherein the thickness of the lithium metal film is 2 to 26 μm.

5. The lithium-ion cell according to claim 2, wherein the thickness of the lithium metal film is 2 to 26 μm.

6. The lithium-ion cell according to claim 3, wherein the thickness of the lithium metal film is 2 to 26 μm.
